(19) United States
(12) Patent Application Publication
(10) Pub. No.: US 2026/0175199 A1
(43) Pub. Date: Jun. 25, 2026

(54) MODIFIED ALUMINOBORATE HAVING INCREASED SURFACE AREA AND METHODS OF MAKING

(71) Applicant: UOP LLC, Des Plaines, IL (US)

(72) Inventors: Kelsey L. Hodge, Hoffman Estates, IL (US); Allison Theberge, Chicago, IL (US); Yili Shi ( Deceased), Des Plaines, IL (US); Richard R. Willis, Cary, IL (US); Sesh Prabhakar, Hoffman Estates, IL (US)

(21) Appl. No.: 19/332,552

(22) Filed: Sep. 18, 2025

Related U.S. Application Data
(60) Provisional application No. 63/736,023, filed on Dec. 19, 2024.

(51) Int. Cl. B01J 21/02; B01J 27/25; B01J 35/61; B01J 35/63; B01J 37/08

(52) U.S. Cl. CPC B01J 21/02; B01J 27/25; B01J 35/615; B01J 35/633; B01J 37/08

(57) ABSTRACT

Salt modified aluminoborates and processes of producing them are described. The salt modified aluminoborate has a weight ratio of Al:B in the range of 5 to 8. It has an XRD diffraction pattern different from the XRD pattern of known aluminoborates. It can be produced using temperatures in the range of 50° C. to 100° C. and a solid:liquid ratio of 1:20 to 1:100 will produce a salt modified aluminoborate with the properties described below. Calcining the salt modified aluminoborate produces different XRD diffraction patterns depending on the temperature used for the calcining.

### RELATED APPLICATIONS

This application claims priority to U.S. Provisional Patent Application Ser. No. 63/736,023, filed on Dec. 19, 2024, the entirety of which is incorporated herein by reference.

### BACKGROUND

The use of aluminoborates and modified aluminoborates as catalysts is known in the literature. For example, the octahedra-based molecular sieve aluminoborate (PKU-1) was reported to be a catalyst for synthesis of a-aminonitriles from imines and TMSCN. (Wang et al., Octahedra-based molecular sieve aluminoborates (PKU-1) as solid acid catalyst for heterogeneously catalyzed Strecker reaction, Catalysis Communications 58 (2015) 174-178.) Fe- and Cr-modified aluminoborates are also known as catalysts. (Wang et al., Fe doped aluminoborate PKU-1 catalysts for the ketalization of glycerol to solketal: Unveiling the effects of iron composition and boron, Chinese Chemical Letters, 33 (2022) 1346-1352; Wang et al., Octahedron-based redox molecular sieves M-PKU-1 (M+Cr, Fe): A novel dual-centered solid acid catalyst for heterogeneously catalyzed Strecker reaction, Applied Catalysis A General 542 (2017) 24-251).

The Al:B weight ratio reported in the literature in in the range of about 1.12 to 1.24 (Li et al., Systematic Study of Cr⁺³ Substitution into Octahedral-Based Microporous Aluminoborates, Inorganic Chemistry, 2014, 53, 5600-5608; and Ju et al., Aluminoborate-Based Molecular Sieves with 18-Octahedral-Atom Channels, Angew. Chem. Int. Ed., 2003, 42, 5607-5610).

While some aluminoborates and modified aluminoborates have been reported in the literature, they typically exhibit lower surface areas than might be expected based on the structure.

There is a need for new aluminoborate materials having increased surface area and microporosity and methods for making them.

### BRIEF DESCRIPTION OF THE DRAWINGS

FIG. 1 shows the XRD patterns of two ammonium nitrate modified aluminoborates of the present invention (Type 2).

FIG. 2 is a comparison of the XRD patterns of the parent aluminoborate, and an ammonium nitrate modified aluminoborate of the present invention (Type 2).

FIG. 3 is a comparison of the cumulative pore volume v. pore width for the parent aluminoborate, a water-washed aluminoborate, and an ammonium nitrate modified aluminoborate of the present invention (Type 2). A Type 1 modification is also shown.

FIG. 4 is a comparison of the XRD patterns of the parent aluminoborate, a water washed aluminoborate, an ammonium nitrate modified aluminoborate of the present invention(Type 2), and a different type of ammonium nitrate modified aluminoborate (Type 1).

FIG. 5 is a comparison of the cumulative pore volume of parent aluminoborate, an ammonium nitrate modified aluminoborate of the present invention, and a different type of ammonium nitrate modified aluminoborate (Type 1), with derivative plots of each.

### DESCRIPTION

Although not wishing to be bound by theory, it is believed that the low surface area of the reported PKU-1 framework is due to H₃BO₃ clusters located within the pores of the material. By selectively removing what is in the pores of this material, the aluminoborates should exhibit higher microporosities. If this is accomplished with the PKU-1-like framework, this would also lead to a 1-dimensional microporous material.

Although not wishing to be bound by theory, it is believed that the process modifies the aluminoborate by selectively removing boron from the crystal structure to improve the surface area. This phenomenon has not been reported previously. The process uses ammonium and other soluble metal salts to remove boron from the crystal structure of the aluminoborate. This is very advantageous due to the increased microporosity and resulting increased surface area.

Two novel salt modified aluminoborates have been developed. The Type 1 salt modified aluminoborate has an Al:B ratio in the range of 1.5 to 2.5, while the Type 2 salt modified aluminoborates has an Al:B ratio in the range of 5 to 8. The XRD diffraction pattern of the Type 1 salt modified aluminoborate is substantially the same as the parent aluminoborate, while the Type 2 salt modified aluminoborate has a different XRD pattern from the parent. The calcined Type 1 and Type 2 salt modified aluminoborates have different XRD patterns from the parent aluminoborate.

Using ¹¹B NMR, it was shown that the boron environment of the modified aluminoborates is changed relative to that of the parent aluminoborate. In the spectra, two distinct three-coordinate boron environments were observed, including two three coordinate boron environments and one four coordinate boron environment. The Type-1 modification has more of the BO₃-1 environment and less of the BO₃-2 environment compared to the parent aluminoborate. The Type-1 modification may have greater than or equal to 75% of the BO₃-1 environment, or greater than or equal to 80%, or greater than or equal to 85%. It may have less than or equal to 25% of the BO₃-2 environment, or less than or equal to 20%, or less than or equal to 15%. It may have less than or equal to 10% of the BO₄ environment.

Relative to the parent, the Type-2 modification had far less of the BO₃-1 environment and started to form some BO₄-coordinate boron. The Type-2 modification may have greater than or equal to 50% of the BO₃-2 environment, or greater than or equal to 60%, or greater than or equal to 70%, or greater than or equal to 75%, or greater than or equal to 80%, or greater than or equal to 85%, or greater than or equal to 90%. It may have less than or equal to 10% of the BO₃-1 environment. It may have less than or equal to 15% of the BO₄ environment.

TABLE 1

| Phase | BO₃-1 | BO₃-2 | BO₄ |
|---|---|---|---|
| Parent (PKU-1-like) | 57-70% | 30-43% | 0-10% |
| Type-1 | 77-91% | 9-23% | 0-10% |
| Type-2 | 0-10% | 84-95% | 0-15% |

The reaction conditions determine which type of salt modified aluminoborate is produced, which in turn determines its properties. U.S. Application Ser. No. 63/735,966, entitled Modified Aluminoborates and Methods of Making, filed Dec. 19, 2024, the entirety of which is incorporated herein by reference, describes one type of salt modified aluminoborate (Type 1). The conditions for making the Type 1 salt modified aluminoborate include temperatures in the range of 20° C. to 40° C. and a solid:liquid weight ratio of 1:20 to 1:100, or temperatures in the range of 50 to 100° C. and a solid:liquid weight ratio of 1:10 to 1:40.

The present application is directed to the Type 2 salt modified aluminoborate. The conditions for producing the Type 2 salt modified aluminoborate include temperatures in the range of 50° C. to 100° C. and a solid:liquid weight ratio of 1:50 to 1:200. It has increased total micropore volume as well as showing a completely new diffraction pattern by XRD. It has shown improved adsorption for trifluoroacetic acid (TFA) which is a PFAS by-product and considered a major contributor to PFAS contamination.

One aspect of the invention is a catalyst composition. In one embodiment, the salt modified aluminoborate has a weight ratio of Al:B in a range of 5 to 8 compared to the Al:B weight ratio for the parent material of 1.25 to 1.48 (as tested—see Examples).

In some embodiments, the salt modified aluminoborate has an XRD diffraction pattern of Table 2:

TABLE 2

| | d-spacing | |
|---|---|---|
| 2θ (°) | (Å) | Intensity |
| 7.89-7.78 | 11.35-11.20 | vs |
| 13.62-13.52 | 6.51-6.46 | m |
| 15.70-15.59 | 5.65-5.61 | w |
| 17.59-17.46 | 5.05-5.01 | vw-w |
| 20.91-20.76 | 4.25-4.23 | w |
| 22.37-22.19 | 3.98-3.95 | vw |
| 23.75-23.58 | 3.75-3.72 | vw |
| 26.13-25.89 | 3.42-3.39 | vw |
| 27.55-27.35 | 3.24-3.21 | vw |
| 28.60-28.43 | 3.12-3.10 | w |
| 30.70-30.49 | 2.92-2.90 | w |
| 31.92-31.73 | 2.80-2.79 | vw |
| 32.91-32.64 | 2.73-2.71 | vw |
| 34.82-34.55 | 2.58-2.56 | vw |
| 35.71-35.48 | 2.52-2.50 | vw-w |
| 38.40-38.11 | 2.35-2.33 | vw |
| 39.29-39.03 | 2.29-2.28 | vw |
| 40.04-39.77 | 2.25-2.24 | vw |
| 41.70-41.43 | 2.17-2.15 | vw |
| 44.69-44.40 | 2.03-2.02 | vw |
| 45.62-45.33 | 1.99-1.98 | vw |
| 46.40-46.10 | 1.96-1.95 | vw |
| 48.57-48.25 | 1.88-1.86 | vw |
| 52.10-51.76 | 1.76-1.74 | vw |

The XRD diffraction pattern for the parent material is shown in Table 3:

TABLE 3

| 2θ° | d-spacing Å | Intensity |
|---|---|---|
| 7.89-8.11 | 11.20-10.89 | vs |
| 13.28-13.56 | 6.66-6.52 | vw |
| 13.77-14.04 | 6.43-6.30 | w |
| 15.49-15.80 | 5.72-5.60 | vw |
| 15.91-16.23 | 5.57-5.46 | vw |
| 17.45-17.77 | 5.08-4.99 | vw |
| 20.81-21.17 | 4.26-4.19 | vw |
| 21.15-21.50 | 4.20-4.13 | vw |
| 22.32-22.68 | 3.98-3.92 | vw |
| 23.71-24.11 | 3.75-3.69 | vw |
| 24.05-24.42 | 3.70-3.64 | vw |
| 25.56-25.96 | 3.48-3.43 | vw |
| 27.57-27.97 | 3.23-3.19 | vw |
| 28.00-28.40 | 3.18-3.14 | vw |
| 28.76-29.18 | 3.10-3.06 | w |
| 30.29-30.72 | 2.95-2.91 | w |
| 30.96-31.39 | 2.89-2.85 | vw |
| 32.27-32.73 | 2.77-2.73 | vw |
| 33.07-33.51 | 2.71-2.67 | vw |
| 35.26-35.76 | 2.54-2.51 | vw |
| 35.96-36.46 | 2.50-2.46 | vw |

In some embodiments, the salt modified aluminoborate has a surface area of 350 m²/g to 500 m²/g compared to 56 m²/g to 178 m²/g for the parent material as tested.

In some embodiments, the salt modified aluminoborate has a total pore volume in a range of 0.4 cc/g to 0.5 cc/g compared to 56 m²/g to 178 m²/g for the parent material as tested.

In some embodiments, the salt modified aluminoborate has a mesopore volume in a range of 0.25 cc/g to 0.35 cc/g compared to 0.13 cc/g to 0.16 cc/g for the parent material as tested.

In some embodiments, the salt modified aluminoborate has a micropore volume in a range of 0.12 cc/g to 0.20 cc/g compared to 0.02 cc/g to 0.07 cc/g for the parent material as tested.

In some embodiments, the salt modified aluminoborate is modified with a salt of ammonium, Li, K, Na, Rb, Cs, Mg, Ca, Sr, Ba, or combinations thereof.

In some embodiments, the salt modified aluminoborate further comprises an M²⁺ ion or an M³⁺ cation.

In some embodiments, the M²⁺ cation or the M³⁺ cation comprises Mg, Ca, Ni, Mn, Co, Zn, Fe, Cr, Rh, Ga, In, Mn, Ti, La, or combinations thereof.

Another aspect of the invention is a process for making a catalyst composition. In one embodiment, the process comprises providing aluminoborate; combining the aluminoborate with a salt in water to form a mixture, wherein a weight ratio of solid:liquid in the mixture is in a range of 1:20 to 1:100; heating the mixture at a temperature in a range of 50° C. to 100° C. to form a salt modified aluminoborate catalyst composition having a weight ratio of Al:B in a range of 5 to 8.

In some embodiments, the salt modified aluminoborate has an XRD diffraction pattern of Table 2:

TABLE 2

| | d-spacing | |
|---|---|---|
| 2θ (°) | (Å) | Intensity |
| 7.89-7.78 | 11.35-11.20 | vs |
| 13.62-13.52 | 6.51-6.46 | m |
| 15.70-15.59 | 5.65-5.61 | w |
| 17.59-17.46 | 5.05-5.01 | vw-w |
| 20.91-20.76 | 4.25-4.23 | w |
| 22.37-22.19 | 3.98-3.95 | vw |
| 23.75-23.58 | 3.75-3.72 | vw |
| 26.13-25.89 | 3.42-3.39 | vw |
| 27.55-27.35 | 3.24-3.21 | vw |
| 28.60-28.43 | 3.12-3.10 | w |
| 30.70-30.49 | 2.92-2.90 | w |
| 31.92-31.73 | 2.80-2.79 | vw |
| 32.91-32.64 | 2.73-2.71 | vw |
| 34.82-34.55 | 2.58-2.56 | vw |
| 35.71-35.48 | 2.52-2.50 | vw-w |
| 38.40-38.11 | 2.35-2.33 | vw |
| 39.29-39.03 | 2.29-2.28 | vw |
| 40.04-39.77 | 2.25-2.24 | vw |
| 41.70-41.43 | 2.17-2.15 | vw |
| 44.69-44.40 | 2.03-2.02 | vw |
| 45.62-45.33 | 1.99-1.98 | vw |
| 46.40-46.10 | 1.96-1.95 | vw |
| 48.57-48.25 | 1.88-1.86 | vw |
| 52.10-51.76 | 1.76-1.74 | vw |

In some embodiments, providing aluminoborate comprises: combining alumina and boric acid; heating the combination of alumina and boric acid at a temperature in a range of 170° C. to 220° C. to form the aluminoborate.

In some embodiments, the process further comprises adding a compound comprising a M²⁺ cation or an M³⁺ cation to the alumina and boric acid.

In some embodiments, the M²⁺ cation or the M³⁺ cation comprises Mg, Ca, Ni, Mn, Co, Zn, Fe, Cr, Rh, Ga, In, Mn, Ti La, or combinations thereof.

In some embodiments, the process further comprises calcining the ammonium nitrate modified aluminoborate catalyst composition at a temperature up to and including 425° C. to form a calcined salt modified aluminoborate catalyst composition having an XRD diffraction pattern of Table 4:

TABLE 4

| 2θ ° | d-spacing Å | Intensity |
|---|---|---|
| 7.93-8.02 | 11.14-11.01 | vs |
| 13.63-13.82 | 6.49-6.40 | w |
| 15.73-15.91 | 5.63-5.57 | w |
| 17.58-17.77 | 5.04-4.99 | vw |
| 20.97-21.22 | 4.23-4.18 | vw |
| 23.74-24.06 | 3.75-3.70 | vw-w |
| 28.68-29.02 | 3.11-3.07 | vw |
| 30.42-30.97 | 2.94-2.88 | vw |

In some embodiments, the process further comprises calcining the salt modified aluminoborate catalyst composition at a temperature in a range of 450° C. to 700° C. to form a calcined salt modified aluminoborate catalyst composition having an XRD diffraction pattern of Table 5:

TABLE 5

| 2θ ° | d-spacing Å | Intensity |
|---|---|---|
| 26.49-26.82 | 3.36-3.32 | vs |
| 36.16-36.96 | 2.48-2.43 | vw-w |
| 42.80-43.38 | 2.11-2.08 | w-m |
| 49.83-50.43 | 1.83-1.81 | w |
| 65.38-66.28 | 1.43-1.41 | m |

The calcined samples showed higher Bronsted acidity and lower Lewis acidity compared to a gamma alumina.

Unmodified aluminoborates can be calcined at higher temperatures than the temperatures used above without losing the sharp XRD diffraction pattern.

In some embodiments, the salt modified aluminoborate has a surface area of 350 m²/g to 500 m²/g.

In some embodiments, the salt modified aluminoborate has a total pore volume in a range of 0.4 cc/g to 0.5 cc/g.

In some embodiments, the salt modified aluminoborate has a mesopore volume in a range of 0.25 cc/g to 0.35 cc/g.

In some embodiments, the salt modified aluminoborate has a micropore volume in a range of 0.12 cc/g to 0.20 cc/g.

### EXAMPLES

### Modifications of Aluminoborates Increasing Surface Area and Adjusting Al:B Ratio

The concept of modifying aluminoborate materials to remove boron from the crystal structure and increase microporosity has been described in U.S. Application No. 63/735,966 entitled Modified Aluminoborates and Methods of Making, (Attorney Docket No. 158440), filed on even date herewith. These salt modified aluminoborates are referred to as Type 1. The present application describes more aggressive conditions that introduce new, larger micropores, as well as producing a diffraction pattern unique to the parent material. Further, the new diffraction pattern has not shown a match to any known material. Using the more aggressive modification conditions, the new composition of matter produces a second salt modified aluminoborate referred to as Type 2.

In a typical modification to make the Type 2 salt modified aluminoborate, 5 g of parent aluminoborate material is added to 500 g of DI water, followed by 4 g of ammonium nitrate. The sample is held at 60° C. with stirring for 3 h, filtered, and dried in an oven at 100° C. Table 1 outlines other modification conditions that yield a similar aluminoborate phase.

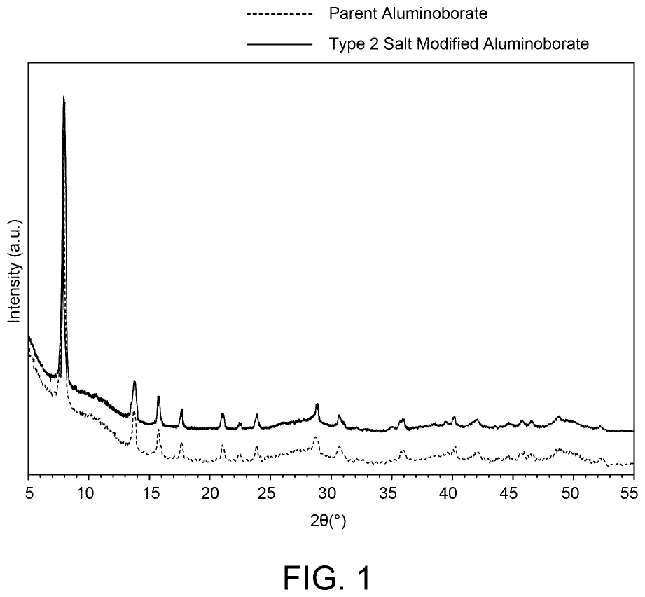

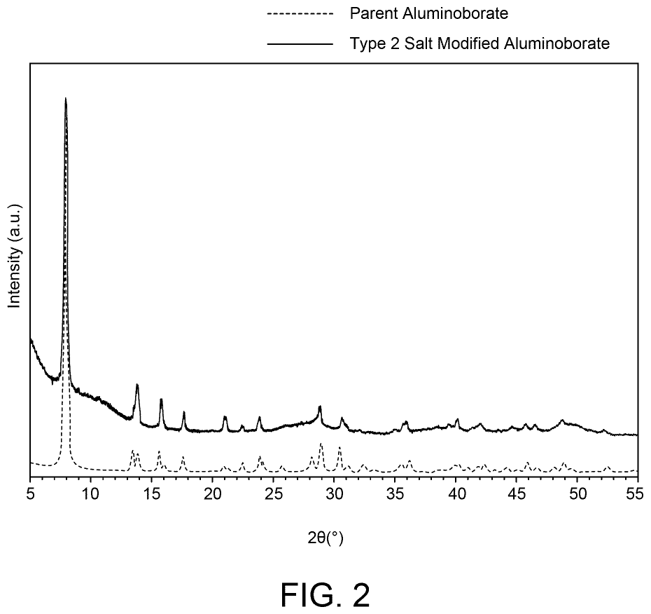

The XRD diffraction patterns from two separate modifications, yielding the Type 2 salt modified aluminoborate are shown in FIG. 1. There is an apparent crystalline phase and a poorly crystalline phase in both patterns. For the more crystalline phase, peak positions and relative intensities are described in Table 2 with a 0.5% tolerance placed on the respective peak positions. The poorly crystalline phase that is present closely resembles that of a poorly crystalline boehmite. The XRD patterns from the parent material and the Type 2 salt modified aluminoborate are shown in FIG. 2. In FIG. 2, the intensity of both diffraction patterns is normalized to the most intense peak. During this kind of modification, the amount of boron that is lost is more than in the less aggressive modifications that form the Type 1 material. By ICP, the parent material is composed of 18% Al and 14% B, and a typical Type 2 salt modified aluminoborate material is composed of 25% Al and 5% B.

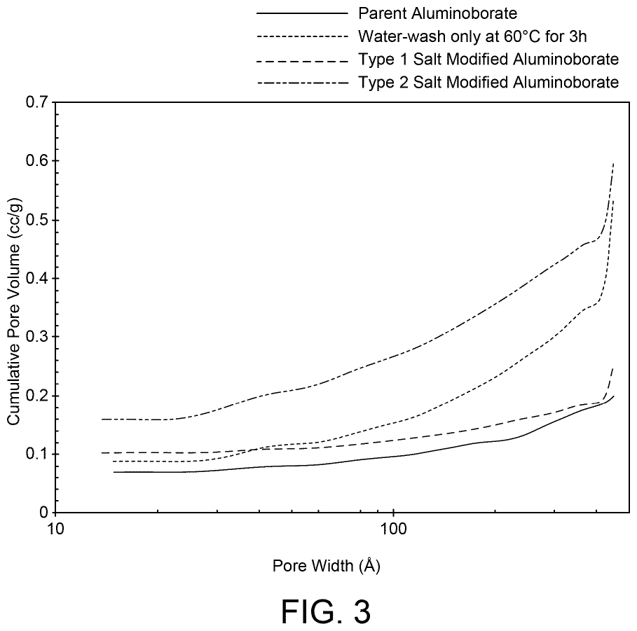

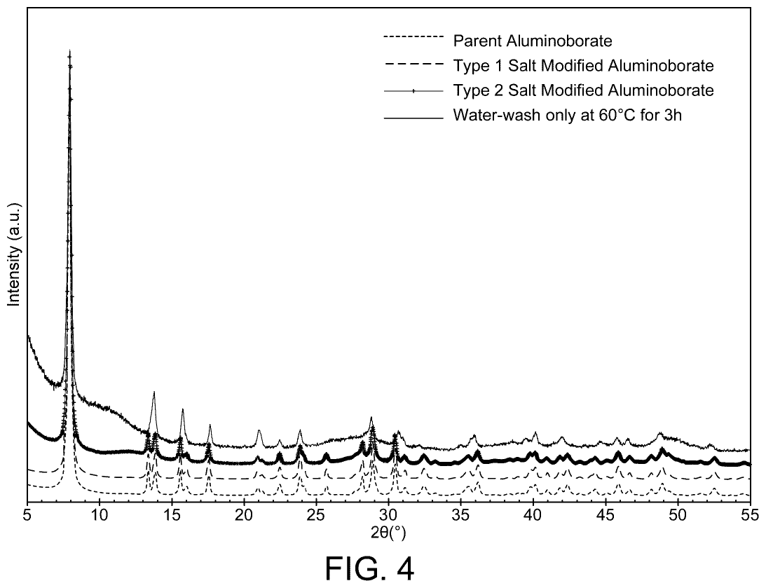

The Type 2 salt modified aluminoborate material has different surface area properties compared to the parent material and the Type 1 material. The cumulative pore volume and pore width plots are shown in FIG. 3 for the parent material, water-wash only at 60° C. for 3 h, Type 1 salt modified aluminoborate, and Type 2 salt modified aluminoborate materials. Both the surface area and comparative XRD patterns (FIG. 4) indicate that, compared to the parent material, the material that was stirred in water at 60° C. in the absence of the ammonium nitrate somewhat decomposes the material, but the total number of peaks in the XRD is unaffected. The microporosity of the material washed with water only slightly increases, but not to the extent that the ammonium nitrate modifications (Type 1 and Type 2) provide.

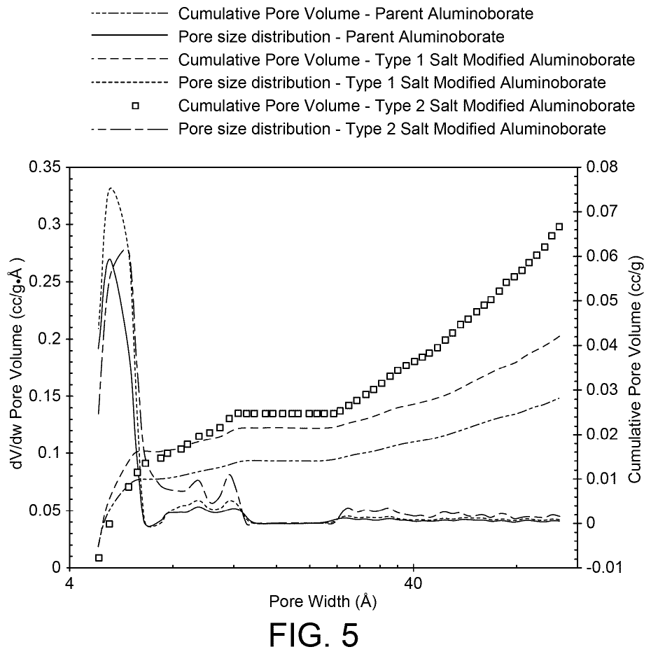

Using the lower N₂ partial pressure data on the parent and salt modified aluminoborate materials, changes in the quantity and distribution of the micropore widths and volumes were observed. FIG. 5 shows the DFT pore size information including the cumulative pore volume and derivative plots. The parent sample's cumulative pore volume and pore size distribution show the lowest total microporosity with most of the microporosity centered around 5.5 Å. The cumulative pore volume of the Type 1 material shows improved microporosity, and the pore size distribution indicates that this treatment removes material from the 5.5 Å micropores with increased volume at that point. This is consistent with the prediction that the Type 1 modification is removing at least some of the boron from the micropores. The cumulative pore volume of the Type 2 material shows improved total microporosity relative to both the parent material and the low water modification conditions. The pore size distribution varies relative to the Type 1 material.

Rather than removing boron from the micropore centered at approximately 5.5 Å, the type 2 material has roughly the same small micropore volume as the parent material. However, it appears that the type 2 material has larger micropores centered at approximately 9.5 and 11.6 Å.

The Type 2 salt modified aluminoborate material has been the best performing aluminoborate material for the adsorption of trifluoroacetic acid, a by-product of PFOA. Results for the aluminoborate materials and the adsorption of trifluoroacetic acid are shown in Table 8.

TABLE 6
Aluminoborate modifications yielding a similar phase.

| | Parent | | | | | | |
|---|---|---|---|---|---|---|---|
| Sample | Sample | | Salt | Water | Concentration | Temp | Solid/ |
| Label | (g) | Salt | Added (g) | (g) | (M) | ° C. | Water |
| A | 10.01 | NH₄NO₃ | 8.05 | 1000.89 | 0.1 | 60 | 0.01 |
| B | 2.06 | NH₄NO₃ | 1.94 | 200.19 | 0.12 | 60 | 0.01 |
| C | 25.02 | NH₄NO₃ | 20.02 | 2500 | 0.1 | 60 | 0.01 |
| D | 25.03 | NH₄NO₃ | 20.19 | 2500 | 0.1 | 60 | 0.01 |
| E | 3.03 | NH₄Cl | 1.61 | 300.02 | 0.1 | 60 | 0.01 |
| F | 3.02 | NaNO₃ | 2.55 | 300.13 | 0.1 | 60 | 0.01 |
| G | 2.99 | NaCl | 1.76 | 300.27 | 0.1 | 60 | 0.01 |
| H | 3.00 | NaCl | 1.75 | 300.16 | 0.1 | 60 | 0.01 |
| I | 3.00 | Na₂CO₃ | 3.18 | 300.05 | 0.1 | 60 | 0.01 |
| J | 5.01 | NH₄NO₃ | 4.04 | 500.11 | 0.1 | 60 | 0.01 |

TABLE 7
Peak positions and relative intensity of crystalline
phase present after modifications.

| 2θ (°) | d-spacing (Å) | Intensity |
|---|---|---|
| 7.89-7.78 | 11.35-11.20 | vs |
| 13.62-13.52 | 6.51-6.46 | m |
| 15.70-15.59 | 5.65-5.61 | w |
| 17.59-17.46 | 5.05-5.01 | vw-w |
| 20.91-20.76 | 4.25-4.23 | w |
| 22.37-22.19 | 3.98-3.95 | vw |
| 23.75-23.58 | 3.75-3.72 | vw |
| 26.13-25.89 | 3.42-3.39 | vw |
| 27.55-27.35 | 3.24-3.21 | vw |
| 28.60-28.43 | 3.12-3.10 | w |
| 30.70-30.49 | 2.92-2.90 | w |
| 31.92-31.73 | 2.80-2.79 | vw |
| 32.91-32.64 | 2.73-2.71 | vw |
| 34.82-34.55 | 2.58-2.56 | vw |
| 35.71-35.48 | 2.52-2.50 | vw-w |
| 38.40-38.11 | 2.35-2.33 | vw |
| 39.29-39.03 | 2.29-2.28 | vw |
| 40.04-39.77 | 2.25-2.24 | vw |
| 41.70-41.43 | 2.17-2.15 | vw |
| 44.69-44.40 | 2.03-2.02 | vw |
| 45.62-45.33 | 1.99-1.98 | vw |
| 46.40-46.10 | 1.96-1.95 | vw |
| 48.57-48.25 | 1.88-1.86 | vw |
| 52.10-51.76 | 1.76-1.74 | vw |

TABLE 8
TFA adsorption of aluminoborate and activated carbon materials
from a 290 ppm fluoride solution. The best performing
aluminoborate material is a type 2 material.

| Solid Adsorbent | % TFA Absorbed |
|---|---|
| Type 2 | 37 |
| Type 1 | 25 |
| Activated Carbon | 1.1 |

### Synthesis of Starting Material

### Example 1

### Synthesis

In a typical synthesis of the PKU-1-like AlBO, 104 g of boehmite (V-251) was combined with 309 g of boric acid directly in a 2 L PTFE liner. The sample was then sealed in a 2 L static autoclave and placed in an oven at 200° C. The autoclave was heated under static conditions and allowed to react at autogenous pressure for a period of 6 days.

### Example 2

### Synthesis

In a typical synthesis of the PKU-1-like AlBO, 1.39 g of boehmite (V-251) was combined with 3.09 g of boric acid directly in a 45 cc PTFE liner. The sample was then sealed in a 45 cc static autoclave and placed in an oven at 200° C. The autoclave was heated under static conditions and allowed to react at autogenous pressure for a period of 6 days.

### Example 3

### Synthesis

In a typical synthesis of the PKU-1-like AlBO, 1.56 g of gibbsite was combined with 3.09 g of boric acid directly in a 45 cc PTFE liner. The sample was then sealed in a 45 cc static autoclave and placed in an oven at 200° C. The autoclave was heated under static conditions and allowed to react at autogenous pressure for a period of 4 days.

### Example 4

### Synthesis

In a typical synthesis of the PKU-1-like AlBO, 1.56 g of bayerite was combined with 3.09 g of boric acid directly in a 45 cc PTFE liner. The sample was then sealed in a 45 cc static autoclave and placed in an oven at 200° C. The autoclave was heated under static conditions and allowed to react at autogenous pressure for a period of 4 days.

### Example 5

### Synthesis

In a typical synthesis of the PKU-1-like AlBO, 0.97 g of flash calcined alumina (FCA) was combined with 3.14 g of boric acid directly in a 45 cc PTFE liner. The sample was then sealed in a 45 cc static autoclave and placed in an oven at 200° C. The autoclave was heated under static conditions and allowed to react at autogenous pressure for a period of 5 days.

### Example 6

### Synthesis

In a typical synthesis of the PKU-1-like AlBO, 1.01 g of gamma alumina (VGL-25) was combined with 3.09 g of boric acid directly in a 45 cc PTFE liner. The sample was then sealed in a 45 cc static autoclave and placed in an oven at 200° C. The autoclave was heated under static conditions and allowed to react at autogenous pressure for a period of 5 days.

### Example 7

### Synthesis

In a typical synthesis of the PKU-1-like AlBO, 1.71 g of boehmite (V-251) was combined with 3.09 g of boric acid directly in a 45 cc PTFE liner. The sample was then sealed in a 45 cc static autoclave and placed in an oven at 200° C. The autoclave was heated under static conditions and allowed to react at autogenous pressure for a period of 4 days.

### Modification of Aluminoborate

### Example 8

### Modification

In a typical modification of the aluminoborate material, 10.01 g of the parent aluminoborate material was added to 1000.89 g of DI water, followed by 8.05 g of ammonium nitrate. The sample was held at 60° C. with stirring for 3 h, then filtered and dried in an oven. Table 1 outlines other modification conditions that yield a similar modified aluminoborate phase.

### Example 9

### Modification

In a typical modification of the aluminoborate material, 3.03 g of the parent aluminoborate material was added to 300.02 g of DI water, followed by 1.61 g of ammonium chloride. The sample was held at 60° C. with stirring for 3 h, then filtered and dried in an oven. Table 1 outlines other modification conditions that yield a similar modified aluminoborate phase.

### Example 10

### Modification

In a typical modification of the aluminoborate material, 3.02 g of the parent aluminoborate material was added to 300.13 g of DI water, followed by 2.55 g of sodium nitrate. The sample was held at 60° C. with stirring for 3 h, then filtered and dried in an oven. Table 1 outlines other modification conditions that yield a similar modified aluminoborate phase.

### Example 10

### Modification

In a typical modification of the aluminoborate material, 2.99 g of the parent aluminoborate material was added to 300.27 g of DI water, followed by 1.76 g of sodium chloride. The sample was held at 60° C. with stirring for 3 h, then filtered and dried in an oven. Table 1 outlines other modification conditions that yield a similar modified aluminoborate phase.

### Example 11

### Modification

In a typical modification of the aluminoborate material, 3.00 g of the parent aluminoborate material was added to 300.05 g of DI water, followed by 3.17 g of sodium carbonate. The sample was held at 60° C. with stirring for 3 h, then filtered and dried in an oven. Table 1 outlines other modification conditions that yield a similar modified aluminoborate phase.

### High Temperature

### Example 12

A total of 2.98 g of the material made in Example 4 was ground and weighed in a calcination dish. The dish was then placed in a furnace at 100° C. that was subsequently ramped at a rate of 2° C./min to 400° C. with a programmed dwelling step of 3 h at that temperature. The furnace was then programmed to cool naturally to 100° C. and the furnace was held at that temperature until the material was removed. The resulting product was then analyzed against the parent material with both XRD and surface area. Relative to the parent material, there was a significant loss in crystallinity of the diffraction pattern and a reduction in the total number of peaks as well as the emergence of a poorly crystalline phase. The poorly crystalline phase is defined in Example 11. The more crystalline phase is characterized by the following diffraction lines:

TABLE 9

| 2θ ° | d-spacing Å | Intensity |
|---|---|---|
| 7.97 | 11.09 | vs |
| 13.70 | 6.46 | w |
| 15.81 | 5.60 | w |
| 17.67 | 5.01 | vw |
| 21.11 | 4.21 | vw |
| 23.94 | 3.71 | w |
| 28.88 | 3.09 | vw |
| 30.57 | 2.92 | vw |

### Example 13

A total of 4.16 g of the material made in Example 4 was ground and weighed in a calcination dish. The dish was then placed in a furnace at 100° C. that was subsequently ramped at a rate of 2° C./min to 600° C. with a programmed dwelling step of 3 h at that temperature. The furnace was then programmed to cool naturally to 100° C. and the furnace was held at that temperature until the material was removed. The resulting product was then analyzed against the parent material with both XRD and surface area. The XRD pattern shows only a poorly crystalline phase present which is demonstrated by the following diffraction lines.

TABLE 10

| 2θ ° | d-spacing Å | Intensity |
|---|---|---|
| 26.68 | 3.34 | vs |
| 36.69 | 2.45 | w |
| 43.35 | 2.09 | m |
| 49.95 | 1.83 | w |
| 65.72 | 1.42 | m |

The calcined materials have been tested for heptene isomerization. Table 11 shows the normalized microreactor data for the Type 1 and Type 2 materials calcined at 400° C. and 600° C. normalized to the conversion and selectivity of the Type 1 ammonium nitrate modified aluminoborate calcined at 400° C.

TABLE 11

| | Relative Conversion | Relative selectivity |
|---|---|---|
| Sample | 400° C. | 400° C. |
| Type 1 400° C. | 1.00 | 1.00 |
| Type 1 600° C. | 1.20 | 2.53 |
| Type 2 400° C. | 1.19 | 2.62 |
| Type 2 600° C. | 1.23 | 4.03 |

### Specific Embodiments

While the following is described in conjunction with specific embodiments, it will be understood that this description is intended to illustrate and not limit the scope of the preceding description and the appended claims.

A first embodiment of the invention is a catalyst composition comprising a salt modified aluminoborate having a weight ratio of Al:B in a range of 5 to 8. An embodiment of the invention is one, any or all of prior embodiments in this paragraph up through the first embodiment in this paragraph wherein the salt modified aluminoborate has an XRD diffraction pattern of Table 2:

TABLE 2

| 2θ (°) | d-spacing (Å) | Intensity |
|---|---|---|
| 7.89-7.78 | 11.35-11.20 | vs |
| 13.62-13.52 | 6.51-6.46 | m |
| 15.70-15.59 | 5.65-5.61 | w |
| 17.59-17.46 | 5.05-5.01 | vw-w |
| 20.91-20.76 | 4.25-4.23 | w |
| 22.37-22.19 | 3.98-3.95 | vw |
| 23.75-23.58 | 3.75-3.72 | vw |
| 26.13-25.89 | 3.42-3.39 | vw |
| 27.55-27.35 | 3.24-3.21 | vw |
| 28.60-28.43 | 3.12-3.10 | w |
| 30.70-30.49 | 2.92-2.90 | w |
| 31.92-31.73 | 2.80-2.79 | vw |
| 32.91-32.64 | 2.73-2.71 | vw |
| 34.82-34.55 | 2.58-2.56 | vw |
| 35.71-35.48 | 2.52-2.50 | vw-w |
| 38.40-38.11 | 2.35-2.33 | vw |
| 39.29-39.03 | 2.29-2.28 | vw |
| 40.04-39.77 | 2.25-2.24 | vw |
| 41.70-41.43 | 2.17-2.15 | vw |
| 44.69-44.40 | 2.03-2.02 | vw |
| 45.62-45.33 | 1.99-1.98 | vw |
| 46.40-46.10 | 1.96-1.95 | vw |
| 48.57-48.25 | 1.88-1.86 | vw |
| 52.10-51.76 | 1.76-1.74 | vw |

An embodiment of the invention is one, any or all of prior embodiments in this paragraph up through the first embodiment in this paragraph wherein the salt modified aluminoborate has a surface area of 350 m²/g to 500 m²/g. An embodiment of the invention is one, any or all of prior embodiments in this paragraph up through the first embodiment in this paragraph wherein the salt modified aluminoborate has a total pore volume in a range of 0.4 cc/g to 0.5 cc/g. An embodiment of the invention is one, any or all of prior embodiments in this paragraph up through the first embodiment in this paragraph wherein the salt modified aluminoborate has a mesopore volume in a range of 0.25 cc/g to 0.35 cc/g. An embodiment of the invention is one, any or all of prior embodiments in this paragraph up through the first embodiment in this paragraph wherein the salt modified aluminoborate has a micropore volume in a range of 0.12 cc/g to 0.20 cc/g. An embodiment of the invention is one, any or all of prior embodiments in this paragraph up through the first embodiment in this paragraph wherein the salt modified aluminoborate is modified with a salt of ammonium, Li, K, Na, Rb, Cs, Mg, Ca, Sr, Ba, or combinations thereof Δn embodiment of the invention is one, any or all of prior embodiments in this paragraph up through the first embodiment in this paragraph wherein the salt modified aluminoborate further comprises an M²⁺ ion or an M³⁺ cation. An embodiment of the invention is one, any or all of prior embodiments in this paragraph up through the first embodiment in this paragraph wherein the M²⁺ cation or the M³⁺ cation comprises Mg, Ca, Ni, Mn, Co, Zn, Fe, Cr, Rh, Ga, In, Mn, Ti, La, or combinations thereof. An embodiment of the invention is one, any or all of prior embodiments in this paragraph up through the first embodiment in this paragraph wherein the salt modified aluminoborate has less BO₃-1 environment than the parent aluminoborate and more BO₃-2 environment than the parent aluminoborate.

A second embodiment of the invention is a process for making a catalyst composition providing aluminoborate; combining the aluminoborate with a salt in water to form a mixture, wherein a weight ratio of solid:liquid in the mixture is in a range of 1:20 to 1:100; heating the mixture at a temperature in a range of 50° C. to 100° C. to form a salt modified aluminoborate catalyst composition having a weight ratio of Al:B in a range of 5 to 8. An embodiment of the invention is one, any or all of prior embodiments in this paragraph up through the second embodiment in this paragraph wherein the salt modified aluminoborate has an XRD diffraction pattern of Table 2:

TABLE 2

| 2θ (°) | d-spacing (Å) | Intensity |
|---|---|---|
| 7.89-7.78 | 11.35-11.20 | vs |
| 13.62-13.52 | 6.51-6.46 | m |
| 15.70-15.59 | 5.65-5.61 | w |
| 17.59-17.46 | 5.05-5.01 | vw-w |
| 20.91-20.76 | 4.25-4.23 | w |
| 22.37-22.19 | 3.98-3.95 | vw |
| 23.75-23.58 | 3.75-3.72 | vw |
| 26.13-25.89 | 3.42-3.39 | vw |
| 27.55-27.35 | 3.24-3.21 | vw |
| 28.60-28.43 | 3.12-3.10 | w |
| 30.70-30.49 | 2.92-2.90 | w |
| 31.92-31.73 | 2.80-2.79 | vw |
| 32.91-32.64 | 2.73-2.71 | vw |
| 34.82-34.55 | 2.58-2.56 | vw |
| 35.71-35.48 | 2.52-2.50 | vw-w |
| 38.40-38.11 | 2.35-2.33 | vw |
| 39.29-39.03 | 2.29-2.28 | vw |
| 40.04-39.77 | 2.25-2.24 | vw |
| 41.70-41.43 | 2.17-2.15 | vw |
| 44.69-44.40 | 2.03-2.02 | vw |
| 45.62-45.33 | 1.99-1.98 | vw |
| 46.40-46.10 | 1.96-1.95 | vw |
| 48.57-48.25 | 1.88-1.86 | vw |
| 52.10-51.76 | 1.76-1.74 | vw |

An embodiment of the invention is one, any or all of prior embodiments in this paragraph up through the second embodiment in this paragraph wherein providing the aluminoborate comprises combining alumina and boric acid; heating the combination of alumina and boric acid at a temperature in a range of 170° C. to 220° C. to form the aluminoborate. An embodiment of the invention is one, any or all of prior embodiments in this paragraph up through the second embodiment in this paragraph further comprising adding a compound comprising a M²⁺ cation or an M³⁺ cation to the alumina and boric acid. An embodiment of the invention is one, any or all of prior embodiments in this paragraph up through the second embodiment in this paragraph wherein the M²⁺ cation or the M³⁺ cation comprises Mg, Ca, Ni, Mn, Co, Zn, Fe, Cr, Rh, Ga, In, Mn, Ti, La, or combinations thereof Δn embodiment of the invention is one, any or all of prior embodiments in this paragraph up through the second embodiment in this paragraph further comprising calcining the ammonium nitrate modified aluminoborate catalyst composition at a temperature up to and including 425° C. to form a calcined salt modified aluminoborate catalyst composition having an XRD diffraction pattern of Table 4:

TABLE 4

| 2θ ° | d-spacing Å | Intensity |
|---|---|---|
| 7.93-8.02 | 11.14-11.01 | vs |
| 13.63-13.82 | 6.49-6.40 | w |
| 15.73-15.91 | 5.63-5.57 | w |
| 17.58-17.77 | 5.04-4.99 | vw |
| 20.97-21.22 | 4.23-4.18 | vw |
| 23.74-24.06 | 3.75-3.70 | vw-w |
| 28.68-29.02 | 3.11-3.07 | vw |
| 30.42-30.97 | 2.94-2.88 | vw |

An embodiment of the invention is one, any or all of prior embodiments in this paragraph up through the second embodiment in this paragraph further comprising calcining the salt modified aluminoborate catalyst composition at a temperature in a range of 450° C. to 700° C. to form a calcined salt modified aluminoborate catalyst composition having an XRD diffraction pattern of Table 5:

TABLE 5

| 2θ ° | d-spacing Å | Intensity |
|---|---|---|
| 26.49-26.82 | 3.36-3.32 | vs |
| 36.16-36.96 | 2.48-2.43 | vw-w |
| 42.80-43.38 | 2.11-2.08 | w-m |
| 49.83-50.43 | 1.83-1.81 | w |
| 65.38-66.28 | 1.43-1.41 | m |

An embodiment of the invention is one, any or all of prior embodiments in this paragraph up through the second embodiment in this paragraph wherein the salt modified aluminoborate has a surface area of 350 m²/g to 500 m²/g. An embodiment of the invention is one, any or all of prior embodiments in this paragraph up through the second embodiment in this paragraph wherein the salt modified aluminoborate has a total pore volume in a range of 0.4 cc/g to 0.5 cc/g; or wherein the salt modified aluminoborate has a mesopore volume in a range of 0.25 cc/g to 0.35 cc/g; or wherein the salt modified aluminoborate has a micropore volume in a range of 0.12 cc/g to 0.20 cc/g; or combinations thereof. An embodiment of the invention is one, any or all of prior embodiments in this paragraph up through the second embodiment in this paragraph wherein the salt modified aluminoborate has less BO₃-1 environment than the parent aluminoborate and more BO₃-2 environment than the parent aluminoborate

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

What is claimed is:

1. A catalyst composition comprising:
a salt modified aluminoborate having a weight ratio of Al:B in a range of 5 to 8.

2. The catalyst composition of claim 1 wherein the salt modified aluminoborate has an XRD diffraction pattern of Table 2:
TABLE 2

| 2θ (°) | d-spacing (Å) | Intensity |
|---|---|---|
| 7.89-7.78 | 11.35-11.20 | vs |
| 13.62-13.52 | 6.51-6.46 | m |
| 15.70-15.59 | 5.65-5.61 | w |
| 17.59-17.46 | 5.05-5.01 | vw-w |
| 20.91-20.76 | 4.25-4.23 | w |
| 22.37-22.19 | 3.98-3.95 | vw |
| 23.75-23.58 | 3.75-3.72 | vw |
| 26.13-25.89 | 3.42-3.39 | vw |
| 27.55-27.35 | 3.24-3.21 | vw |
| 28.60-28.43 | 3.12-3.10 | w |
| 30.70-30.49 | 2.92-2.90 | w |
| 31.92-31.73 | 2.80-2.79 | vw |
| 32.91-32.64 | 2.73-2.71 | vw |
| 34.82-34.55 | 2.58-2.56 | vw |
| 35.71-35.48 | 2.52-2.50 | vw-w |
| 38.40-38.11 | 2.35-2.33 | vw |
| 39.29-39.03 | 2.29-2.28 | vw |
| 40.04-39.77 | 2.25-2.24 | vw |
| 41.70-41.43 | 2.17-2.15 | vw |
| 44.69-44.40 | 2.03-2.02 | vw |
| 45.62-45.33 | 1.99-1.98 | vw |
| 46.40-46.10 | 1.96-1.95 | vw |
| 48.57-48.25 | 1.88-1.86 | vw |
| 52.10-51.76 | 1.76-1.74 | vw |

3. The catalyst composition of claim 1 wherein the salt modified aluminoborate has a surface area of 350 m²/g to 500 m²/g.

4. The catalyst composition of claim 1 wherein the salt modified aluminoborate has a total pore volume in a range of 0.4 cc/g to 0.5 cc/g.

5. The catalyst composition of claim 1 wherein the salt modified aluminoborate has a mesopore volume in a range of 0.25 cc/g to 0.35 cc/g.

6. The catalyst composition of claim 1 wherein the salt modified aluminoborate has a micropore volume in a range of 0.12 cc/g to 0.20 cc/g.

7. The catalyst composition of claim 1 wherein the salt modified aluminoborate is modified with a salt of ammonium, Li, K, Na, Rb, Cs, Mg, Ca, Sr, Ba, or combinations thereof.

8. The catalyst composition of claim 1 wherein the salt modified aluminoborate further comprises an M²⁺ ion or an M³⁺ cation.

9. The catalyst composition of claim 8 wherein the M²⁺ cation or the M³⁺ cation comprises Mg, Ca, Ni, Mn, Co, Zn, Fe, Cr, Rh, Ga, In, Mn, Ti, La, or combinations thereof.

10. The catalyst composition of claim 1 wherein the salt modified aluminoborate has less BO₃-1 environment than the parent aluminoborate and more BO₃-2 environment than the parent aluminoborate.

11. A process for making a catalyst composition:
providing aluminoborate;
combining the aluminoborate with a salt in water to form a mixture, wherein a weight ratio of solid:liquid in the mixture is in a range of 1:20 to 1:100; and
heating the mixture at a temperature in a range of 50° C. to 100° C. to form a salt modified aluminoborate catalyst composition having a weight ratio of Al:B in a range of 5 to 8.

12. The process of claim 11 wherein the salt modified aluminoborate has an XRD diffraction pattern of Table 2:
TABLE 2

| 2θ (°) | d-spacing (Å) | Intensity |
|---|---|---|
| 7.89-7.78 | 11.35-11.20 | Vs |
| 13.62-13.52 | 6.51-6.46 | M |
| 15.70-15.59 | 5.65-5.61 | W |
| 17.59-17.46 | 5.05-5.01 | vw-w |
| 20.91-20.76 | 4.25-4.23 | W |
| 22.37-22.19 | 3.98-3.95 | Vw |
| 23.75-23.58 | 3.75-3.72 | Vw |
| 26.13-25.89 | 3.42-3.39 | Vw |
| 27.55-27.35 | 3.24-3.21 | Vw |
| 28.60-28.43 | 3.12-3.10 | W |
| 30.70-30.49 | 2.92-2.90 | w |
| 31.92-31.73 | 2.80-2.79 | vw |
| 32.91-32.64 | 2.73-2.71 | vw |
| 34.82-34.55 | 2.58-2.56 | vw |
| 35.71-35.48 | 2.52-2.50 | vw-w |
| 38.40-38.11 | 2.35-2.33 | vw |
| 39.29-39.03 | 2.29-2.28 | vw |
| 40.04-39.77 | 2.25-2.24 | vw |
| 41.70-41.43 | 2.17-2.15 | vw |
| 44.69-44.40 | 2.03-2.02 | vw |
| 45.62-45.33 | 1.99-1.98 | vw |
| 46.40-46.10 | 1.96-1.95 | vw |
| 48.57-48.25 | 1.88-1.86 | vw |
| 52.10-51.76 | 1.76-1.74 | vw |

13. The process of claim 11 wherein providing the aluminoborate comprises:
combining alumina and boric acid; and
heating the combination of alumina and boric acid at a temperature in a range of 170° C. to 220° C. to form the aluminoborate.

14. The process of claim 11 further comprising:
adding a compound comprising a M²⁺ cation or an M³⁺ cation to the alumina and boric acid.

15. The process of claim 14 wherein the M²⁺ cation or the M³⁺ cation comprises Mg, Ca, Ni, Mn, Co, Zn, Fe, Cr, Rh, Ga, In, Mn, Ti, La, or combinations thereof.

16. The process of claim 11 further comprising:
calcining the ammonium nitrate modified aluminoborate catalyst composition at a temperature up to and including 425° C. to form a calcined salt modified aluminoborate catalyst composition having an XRD diffraction pattern of Table 4:
TABLE 4

| 2θ ° | d-spacing Å | Intensity |
|---|---|---|
| 7.93-8.02 | 11.14-11.01 | vs |
| 13.63-13.82 | 6.49-6.40 | w |
| 15.73-15.91 | 5.63-5.57 | w |
| 17.58-17.77 | 5.04-4.99 | vw |
| 20.97-21.22 | 4.23-4.18 | vw |
| 23.74-24.06 | 3.75-3.70 | vw-w |
| 28.68-29.02 | 3.11-3.07 | vw |
| 30.42-30.97 | 2.94-2.88 | vw |

17. The process of claim 11 further comprising:
calcining the salt modified aluminoborate catalyst composition at a temperature in a range of 450° C. to 700° C. to form a calcined salt modified aluminoborate catalyst composition having an XRD diffraction pattern of Table 5:
TABLE 5

| 2θ ° | d-spacing Å | Intensity |
|---|---|---|
| 26.49-26.82 | 3.36-3.32 | vs |
| 36.16-36.96 | 2.48-2.43 | vw-w |
| 42.80-43.38 | 2.11-2.08 | w-m |
| 49.83-50.43 | 1.83-1.81 | w |
| 65.38-66.28 | 1.43-1.41 | m |

18. The process of claim 11 wherein the salt modified aluminoborate has a surface area of 350 m²/g to 500 m²/g.

19. The process of claim 11 wherein the salt modified aluminoborate has a total pore volume in a range of 0.4 cc/g to 0.5 cc/g, or
wherein the salt modified aluminoborate has a mesopore volume in a range of 0.25 cc/g to 0.35 cc/g; or wherein the salt modified aluminoborate has a micropore volume in a range of 0.12 cc/g to 0.20 cc/g;
or combinations thereof.

20. The process of claim 11 wherein the salt modified aluminoborate has less BO₃-1 environment than the parent aluminoborate and more BO₃-2 environment than the parent aluminoborate.
